(19) United States
(12) Patent Application Publication
(10) Pub. No.: US 2008/0123743 A1
(43) Pub. Date: May 29, 2008

(54) INTERPOLATED FRAME GENERATING METHOD AND INTERPOLATED FRAME GENERATING APPARATUS

(75) Inventors: Kenichi Douniwa, Asaka-shi (JP); Masaya Yamasaki, Hachioji-shi (JP); Yohei Hamakawa, Fussa-shi (JP); Atsuo Shono, Tachikawa-shi (JP); Hiroshi Yoshimura, Saitama-shi (JP); Keiko Hirayama, Tokyo (JP); Ko Sato, Ome-shi (JP); Yoshihiko Ogawa, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/945,548

(22) Filed: Nov. 27, 2007

(30) Foreign Application Priority Data
Nov. 28, 2006 (JP) 2006-320618

(51) Int. Cl. H04N 7/26

(52) U.S. Cl. 375/240.15; 375/E07.125; 375/E07.031

(57) ABSTRACT

According to one embodiment, an interpolated frame generating method of generating a new interpolated frame to be inserted between sequential frames by using a plurality of input frame images, comprises detecting a motion vector of an object in frame images by block matching processing between the input frame images, determining certainty of the motion vector detected in the detecting, and determining a certain motion vector and an uncertain motion vector based on a result of the determining, and generating the interpolated frame by using the motion vector detected in the detecting. The generating is generating the interpolated frame by setting a value of a motion vector determined as an uncertain motion vector in the determining to zero.

### CROSS-REFERENCE TO RELATED APPLICATIONS

This application is based upon and claims the benefit of priority from Japanese Patent Application No. 2006-320618, filed Nov. 28, 2006, the entire contents of which are incorporated herein by reference.

### BACKGROUND

1. Field

One embodiment of the present invention relates to a technique of generating and inserting an interpolated frame between frame images forming moving images, and displaying movement of an object as smooth and natural movement.

2. Description of the Related Art

When moving images are displayed on a liquid crystal display (LCD), the LCD displays frame images (hereinafter simply referred to as “frames”) at a rate of, for example, 60 frames/second. The frames are sequential scanning images obtained by processing interlaced signals of 60 fields/second. Specifically, LCDs display one frame for 1/60 second.

When such images displayed on LCDs are viewed, an image of previous frame is left as persistence of vision for viewer's eyes. Therefore, there are cases where a moving object in the images appears blurred, or movement of the object appears unnatural. Such a phenomenon appears more conspicuously in larger screens.

To prevent such blurring of moving images, there is a known method of displaying moving images by inserting an interpolated frame between two sequential frames (refer to Jpn. Pat. Appln. KOKAI Pub. No. 2005-6275). In the method of the reference, matching of image blocks forming frames is performed between two input frames including a prior frame and a subsequent frame or more input frames, and thereby a motion vector of each block (direction and distance of movement of the object) is detected. A new interpolated frame located between the input frames is generated by using the motion vector of each block. The interpolated frame is inserted between the two input frames, and thereby moving images are displayed with increased number of frames.

The above block matching is a method of detecting which image block in a subsequent frame an image block of a predetermined size in a frame matches. A difference between a pixel of one image block in the prior frame and a corresponding pixel of any one image block in the subsequent frame is calculated, and an image block of the subsequent frame having minimum cumulative value of difference (sum of absolute difference [SAD]) is detected as an image block which is most similar to the image block of the prior frame. A difference of position between the most similar blocks of the prior frame and the subsequent frame is detected as a motion vector.

When movement of an object is estimated based on block matching using SAD, if a periodical pattern exists in input frames, an accurate motion vector cannot be estimated in image blocks in the periodical pattern. Jpn. Pat. Appln. KOKAI Pub. No. 2005-56410 discloses a technique of correcting a motion vector of an image block with motion vectors of surrounding image blocks, if an observed image is a periodical pattern. Further, a technique of using blocks of two sizes to detect a motion vector is filed as Jpn. Pat. Appln. No. 2006-208792 (filed on Jul. 31, 2006).

The accuracy of detecting a motion vector by using block matching is not perfect, and detecting sometimes ends in failure. Failure in detecting a motion vector has large influence on image processing, and causes breakdown of images. Therefore, it is required to take measures against failure in detecting a motion vector.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating an embodiment of an interpolated frame generating apparatus according to the present invention;

FIG. 2 is a diagram for explaining an example of block matching processing;

FIG. 3 is a schematic diagram illustrating an example of a method of determining certainty of a motion vector;

FIG. 4 is a flowchart illustrating a processing procedure of an interpolated frame generating apparatus 10, which is performed according to the method shown in FIG. 3;

FIG. 5 is a schematic diagram illustrating another example of the method of determining certainty of a motion vector; and

FIG. 6 is a flowchart illustrating a processing procedure of the interpolated frame generating apparatus 10, which is performed according to the method shown in FIG. 5.

### DETAILED DESCRIPTION

Various embodiments according to the invention will be described hereinafter with reference to the accompanying drawings. In general, according to one embodiment of the invention, there is provided an interpolated frame generating method of generating a new interpolated frame to be inserted between sequential frames by using a plurality of input frame images, comprising: detecting a motion vector of an object in frame images by block matching processing between the input frame images; determining certainty of the motion vector detected in the detecting, and determining a certain motion vector and an uncertain motion vector based on a result of the determining; and generating the interpolated frame by using the motion vector detected in the detecting, wherein the generating is generating the interpolated frame by setting a value of a motion vector determined as an uncertain motion vector in the determining to zero.

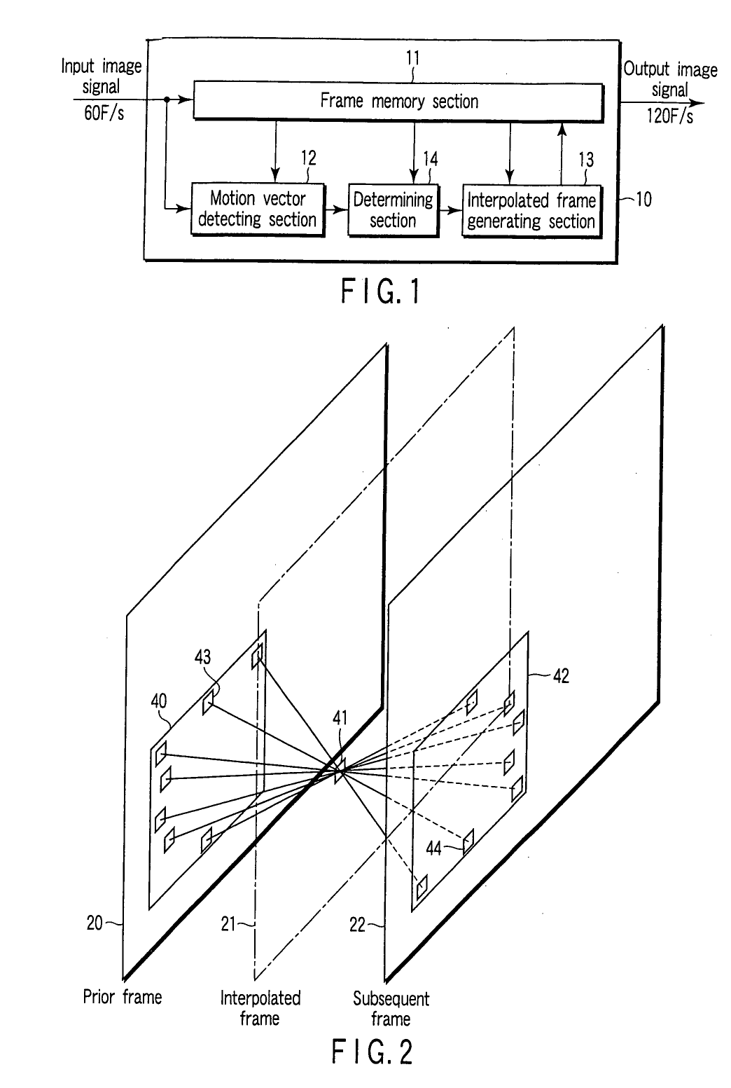

FIG. 1 is a block diagram illustrating an embodiment of an interpolated frame generating apparatus (frame number changing apparatus) according to the present invention. An interpolated frame generating apparatus 10 of FIG. 1 comprises a frame memory section 11, a motion vector detecting section 12, an interpolated frame generating section 13, and a determining section 14. The motion vector detecting section 12 detects a motion vector from, for example, two sequential frames in an input image signal by block matching processing. Specifically, the motion vector detecting section 12 calculates an absolute difference value between values of corresponding pixels of image blocks in two input frame images, and selects a motion vector corresponding to a minimum value of SAD of the absolute difference value as a potential motion vector. The frame rate of input image signals is, for example, 60 frames/second.

The interpolated image generating section 13 generates an interpolated frame on the basis of a detection result of the motion vector detecting section 12, and inserts the interpolated frame between the two frames. The frame rate of an output image signal, in which interpolated frames are inserted, is 120 frames/second, for example.

The determining section 14 determines certainty of a motion vector detected by the motion vector detecting section 12. Specifically, the determining section 14 determines certainties of motion vectors detected by the motion vector detecting section 12, and distinguishes certain motion vectors from uncertain motion vectors based on a detection result. In particular, the determining section 14 determines a vector, which has a magnitude equal to or larger than a specified threshold value, as an uncertain motion vector. As another example, the determining section 14 determines a vector, whose matching rate with motion vectors of pixels surrounding a pixel corresponding to the vector (the motion vector to be determined) does not exceed a specified threshold value, as an uncertain vector.

Specifically, the determining section 14 determines, for each pixel, whether a detected motion vector is correct or not. Then, the determining section 14 determines whether to generate an interpolated frame by using the detected motion vector, to generate an interpolated frame by using a motion vector of a surrounding block, or to generate an interpolated frame by using a motion vector of zero. Thereafter, the determining section 14 provides a result of the determination to the interpolated image generating section 13. The interpolated image generating section 13 generates an interpolated image, on the basis of the determination result of the determining section 14.

The interpolated image generating section 13 generates an interpolated frame by using the motion vector detected by the motion vector detecting section 12. When generating an interpolated frame, the interpolated image generating section 13 regards the motion vector, which is determined as an uncertain motion vector by the determining section 14, as a vector of zero. As another generating method, the interpolated image generating section 13 generates an interpolated frame by combining (blending) an image, which is generated based on a motion vector determined by the determining section 14 as a certain motion vector, with an image which is generated by using a motion vector determined as an uncertain motion vector as a vector of zero.

The motion vector determining section 12, the interpolated image generating section 13, and the determining section 14 can be formed of hardware using discrete electronic circuits, or software executed by a CPU (not shown).

FIG. 2 is a diagram for explaining an example of block matching processing. As illustrated in FIG. 2, there is a method of determining a motion vector through block matching processing between image blocks which are symmetric with respect to a point. Specifically, in the method of FIG. 2, an SAD is calculated by comparing image blocks on a prior frame 20 and a subsequent frame 22, which hold an interpolated frame 21 therebetween, pixel by pixel. The image blocks are symmetric with respect to a point in an inserting position of an interpolated image block 41 in an interpolated frame 21. The size of image blocks used in this processing is selected from two sizes. A vector which connects most similar image blocks (that is, having the smallest SAD) is determined as a motion vector. This comparison is performed in a predetermined search range 40 in the prior frame 20 and a search range 42 in the subsequent frame 22, which corresponds to the search range 40.

Supposing that an image block 43 and an image block 44 form a pair of most similar image blocks, a vector from the image block 43 to the image block 44 is determined as a motion vector of the interpolated image block 41. The interpolated image block 41 in the interpolated frame 21 is generated, on the basis of the motion vector and data of the image blocks 43 and 44 which are most similar to each other.

In the method illustrated in FIG. 2, a block of a predetermined size is moved in parallel on two frames holding an interpolated frame therebetween, with respect to a point in an insertion position of the interpolated frame image. Then, a differential value between pixel values of pixels located in corresponding positions on the two frames is calculated for each of the pixels in the block, and a value which is a cumulative sum of the differential values is determined. A direction in which the SAD has a minimum value is determined as a motion vector of the block.

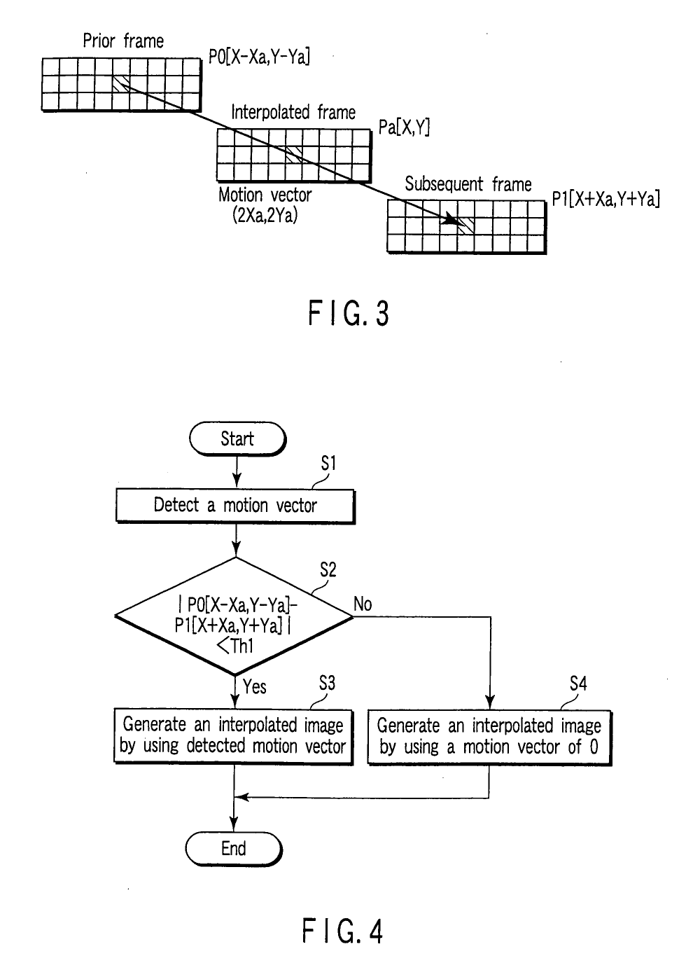

FIG. 3 is a schematic diagram illustrating an example of a method of determining certainty of a motion vector. FIG. 4 is a flowchart illustrating a processing procedure of the interpolated frame generating apparatus 10, which is performed according to the method of FIG. 3. In FIG. 3, suppose that a detected motion vector to be determined is (2Xa, 2Ya) (block S1 of FIG. 4). Then, the determining section 14 determines the certainty (whether the vector is a correct vector or not) of the motion vector of an interpolated image Pa[X, Y] by using the following equation (1) (Block S2).

|P0[X−Xa,Y−Ya]−P1[X+Xa,Y+Ya]|<Th1 (1)

In the equation (1), Th1 on the right side is a specified threshold value. The left side indicates an absolute value of the differential vector. When the equation (1) holds for the detected motion vector, the determining section 14 determines that the detected motion vector is correct, and generates an interpolated frame by using the motion vector (Block S3).

When the equation (1) does not hold true, the determining section 14 notifies the interpolated image generating section 13 thereof. On receiving the notification, the interpolated image generating section 13 generates an interpolated frame by using a motion vector of zero (Block S4).

As described above, according to the above embodiment, an absolute value of a differential vector between a prior frame and a subsequent frame of the interpolated frame is compared with a specified threshold value Th1, and a motion vector whose absolute value of a differential vector is smaller than the threshold value Th1 is determined as a certain motion vector. A vector for which the above condition does not hold is determined as an uncertain motion vector. Then, an interpolated frame is generated by using a motion vector determined as a certain motion vector. Further, when a motion vector is determined as an uncertain motion vector, an interpolated frame is generated by using a motion vector of zero. According to the above structure, uncertain motion vectors can be eliminated in generation of interpolated frames. Therefore, it is possible to provide an interpolated frame generating method and an interpolated frame generating apparatus, which can prevent breakdown of images regardless of the detection accuracy of the motion vector.

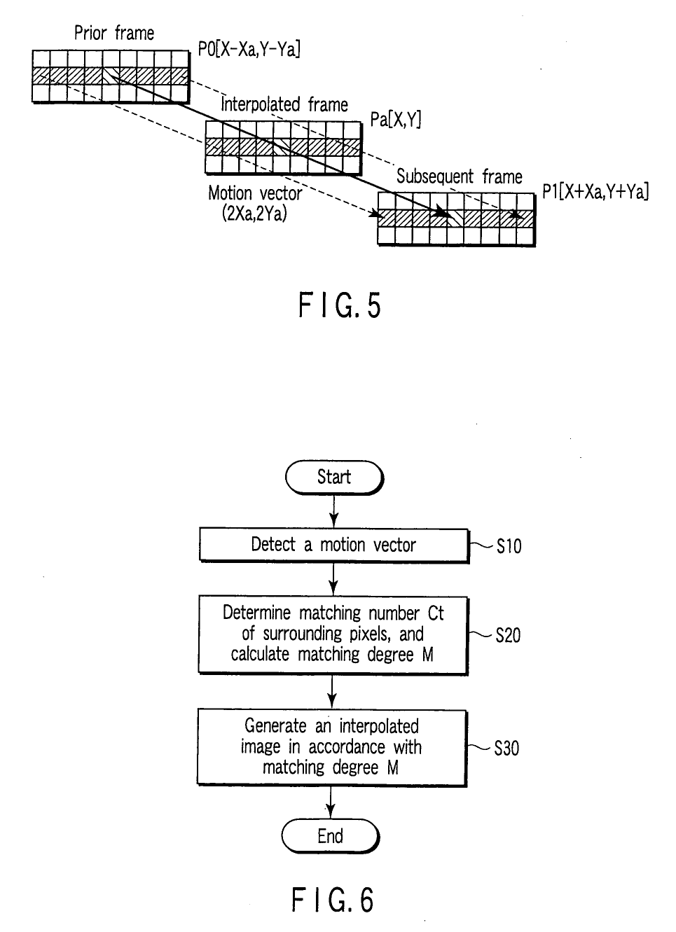

The present invention is not limited to the above embodiment. FIG. 5 is a schematic diagram illustrating another example of the method of determining certainty of a motion vector. FIG. 6 is a flowchart illustrating a processing procedure of the interpolated frame generating apparatus 10 according to the method of FIG. 5. In FIG. 5, suppose that a detected motion vector to be determined is (2Xa, 2Ya) (Block S10 of FIG. 6). Then, the determining section 14 determines the certainty of the motion vector of an interpolated image Pa[X, Y]. Specifically, the determining section 14 determines the certainty of the motion vector of an interpolated image Pa[X, Y] by detecting whether the left and right n pixels Pa[X′, Y′] of a pixel of the image Pa[X, Y] match or not. In this process, the following equation (2) is used (Block S20).

|P0[X′−Xa,Y′−Ya]−P1[X′+Xa,Y′+Ya]|<Th2 (2)

In the equation (2), Th2 on the right side is a specified threshold value. The left side indicates an absolute value of a differential vector. The interpolated image generating section 13 determines the number Ct of surrounding pixels for which the equation (2) holds, and calculates the rate M of the number (0≦M≦1) (Block S20). Then, the interpolated image generating section 13 generates an interpolated image in accordance with the rate (the degree of matching) M (Block S30). Specifically, the interpolated image generating section 13 generates an interpolated frame by blending an image generated by using the detected motion vector with an image generated by using a motion vector of zero. Specifically, the interpolated image generating section 13 generates an interpolated frame based on the following equation (3), where an interpolated image generated by using the detected motion vector is Pv[X, Y], and an interpolated image generated by using a motion vector of zero is Pv0 [X, Y].

Pa[X,Y]=Pv[X,Y]×M+Pv0[X,Y]×(1−M) (3)

M is not simply used as the rate of the number of matching, but a larger weight may be assigned to pixels directly adjacent to the object pixel, and the weight may be gradually decreased as the pixel to be checked goes away from the object pixel. Further, although the matching degree is determined only with respect to the horizontal direction (X-axis) in FIG. 5, it is possible to use the matching degree determined with respect to the vertical direction (Y-axis). Furthermore, the matching degree may be determined with respect to the whole block.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interpolated frame generating method of generating a new interpolated frame to be inserted between sequential frames by using a plurality of input frame images, comprising:
detecting a motion vector of an object in frame images by block matching processing between the input frame images;
determining certainty of the motion vector detected in the detecting, and determining a certain motion vector and an uncertain motion vector based on a result of the determining; and
generating the interpolated frame by using the motion vector detected in the detecting,
wherein
the generating is generating the interpolated frame by setting a value of a motion vector determined as an uncertain motion vector in the determining to zero.

2. An interpolated frame generating method according to claim 1, wherein
the generating is generating the interpolated frame by combining an image generated based on a motion vector, which is determined as a certain motion vector in the determining, with an image generated based on a motion vector, which is determined as an uncertain motion vector in the determining and whose value is set to zero.

3. An interpolated frame generating method according to claim 1, wherein
the determining is determining a vector having a value equal to or larger than a specified threshold value as the uncertain motion vector.

4. An interpolated frame generating method according to claim 1, wherein
the determining is determining a motion vector to be determined, whose matching rate with motion vectors of pixels surrounding a pixel corresponding to the motion vector to be determined is equal to or less than a specified threshold value, as the uncertain motion vector.

5. An interpolated frame generating apparatus generating a new interpolated frame to be inserted between sequential frames by using a plurality of input frame images, comprising:
a detecting section which detects a motion vector of an object in frame images by block matching processing between the input frame images;
a determining section which determines certainty of the motion vector detected in the detecting section, and determines a certain motion vector and an uncertain motion vector based on a result of the determination; and
a generating section which generates the interpolated frame by using the motion vector detected in the detecting,
wherein
the generating section generates the interpolated frame, by setting a value of a motion vector determined as an uncertain motion vector in the determining to zero.

6. An interpolated frame generating apparatus according to claim 5, wherein
the generating section generates the interpolated frame by combining an image generated based on a motion vector, which is determined as a certain motion vector in the determining, with an image generated based on a motion vector, which is determined as an uncertain motion vector in the determining and whose value is set to zero.

7. An interpolated frame generating apparatus according to claim 5, wherein
the determining section determines a vector having a value equal to or larger than a specified threshold value as the uncertain motion vector.

8. An interpolated frame generating apparatus according to claim 5, wherein
the determining section determines a motion vector to be determined, whose matching rate with motion vectors of pixels surrounding a pixel corresponding to the motion vector to be determined is equal to or less than a specified threshold value, as the uncertain motion vector.
